(19) United States
(12) Patent Application Publication
(10) Pub. No.: US 2018/0270373 A1
(43) Pub. Date: Sep. 20, 2018

(54) PORTABLE PANEL OF A PRINTER SYSTEM

(71) Applicants: KABUSHIKI KAISHA TOSHIBA, Tokyo (JP); TOSHIBA TEC KABUSHIKI KAISHA, Tokyo (JP)

(72) Inventors: F. Kumar, Bangalore (IN); Mahesh Kumar Veloo, Bangalore (IN)

(73) Assignees: KABUSHIKI KAISHA TOSHIBA, Tokyo (JP); TOSHIBA TEC KABUSHIKI KAISHA, Tokyo (JP)

(21) Appl. No.: 15/923,827

(22) Filed: Mar. 16, 2018

(30) Foreign Application Priority Data
Mar. 17, 2017 (IN) 201741009270

(51) Int. Cl. H04N 1/00; G06F 3/12

(52) U.S. Cl. CPC H04N 1/00525; G06F 3/1292; H04N 1/00538; H04N 2201/007; H04N 1/00901; H04N 2201/0096; H04N 1/00076

(57) ABSTRACT

A portable panel of a printer system is provided. The portable panel includes an interlock mechanism, a scanner and a panel processor. The interlock mechanism facilitates engaging and disengaging a portable panel from the printer system. The scanner is for scanning information. The panel processor is configured to store the scanned information in a memory unit of the portable panel. The panel processor also performs one of mounting or unmounting of the portable panel from the printer system.

### CROSS REFERENCE TO RELATED APPLICATIONS

This application claims the benefit of priority to Indian Patent Application No. 201741009270, filed Mar. 17, 2017, the entire contents of which are incorporated herein by reference.

### FIELD

The present disclosure relates to a portable device. More specifically, but not exclusively, the present disclosure relates to a portable panel of a printer system. The portable panel can be attached and detached from the printer system, while capable of performing desired functions when attached and detached from the printer system.

### BACKGROUND

Modern printer systems are advanced and can perform various functions. The functions a printer may perform include, but are not limited to, printing, scanning, and copying. All these functions are configured with a printer, making it a multi-functional printer. Traditionally, these multi-functional printers or printer systems have a built-in scanner unit and are not portable.

In a scenario, when a user wants to scan certain documents, the user must be present at the location of the printer systems with all the documents which the user intends to scan. Also, since the printer systems are not portable, it would be difficult for the user to get the printer to his location for scanning the documents. Hence, the existing printer systems cause inconvenience to the user. This inconvenience may affect day to day activities of the user.

Generally, a scanner unit is integral part of the printer systems, so any failure to the scanner unit may result in halting the entire operation of the printer system and the printer system becomes idle till troubleshooting is completed. This would result in a waste of resources and time, and eventually affect the productivity of the user and the company. In case troubleshooting of the scanner unit is not possible, the entire printer system may be replaced with a new printer system. This would result in a huge resource loss to the company.

The information disclosed in this background of the disclosure section is only for enhancement of understanding of the general background and should not be taken as an acknowledgement or any form of suggestion that this information forms the prior art already known to a person skilled in the art.

### BRIEF DESCRIPTION OF THE DRAWINGS

The disclosure will best be understood by reference to the following detailed description of illustrative embodiments when read in conjunction with the accompanying figures. One or more embodiments are now described, by way of example only, with reference to the accompanying figures, wherein like reference numerals represent like elements, and in which:

FIG. 1A illustrates a portable panel engaged with a printer system in accordance with some embodiments of the present disclosure;

FIG. 1B illustrates a portable panel disengaged from a printer system in accordance with some embodiments of the present disclosure;

FIG. 2A illustrates an exemplary diagram of a portable panel in accordance with some embodiments of the present disclosure;

FIG. 2B illustrates a side view of a portable panel in accordance with some embodiments of the present disclosure;

FIG. 3 illustrates an internal architecture of a portable panel in accordance with some embodiments of the present disclosure;

FIG. 4 illustrates wireless communication between the printer system and the portable panel in accordance with some embodiments of the present disclosure; and

FIG. 5 shows an exemplary flow chart illustrating method steps for operating a portable panel in accordance with some embodiments of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable media and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Embodiments of the present disclosure relate to a portable panel of a printer system. The portable panel can be engaged or disengaged from the printer system. Further, the portable panel can communicate with the printer system when engaged and disengaged from the printer system. In at least one embodiment, the portable panel comprises a scanning module for performing functions related to scanning information.

In at least one embodiment, the present disclosure relates to a portable assembly of a printer system. The portable assembly comprises an interlock mechanism for engaging and disengaging a portable panel from the printer system, a scanning module for scanning information, and a processor configured to store the scanned information in a memory unit of the portable panel and perform at least one of mounting or unmounting of the portable panel from the printer system.

In at least one embodiment, the present disclosure relates to a printer system. The printer system comprises a provision for engaging and disengaging a portable panel from the printer system, a network interface to connect to a wireless network, for receiving scanned information from the portable panel when the portable panel is disengaged from the printer system, a physical interface for receiving the scanned information from the portable panel when the portable panel is engaged with the printer system, and a printer processor capable of communicating with the panel processor to enable mounting and unmounting of the portable panel from the printer system.

In at least one embodiment, the present disclosure relates to a method of operating a portable scanner of a printer system. The method comprises receiving, by the portable panel, information to be scanned, detecting physical engagement of the portable panel with a printer system, where the portable panel comprises an interlock mechanism for engaging and disengaging from the printer system, receiving power from one of the printer system and a power source of the portable panel based on the detection of physical engagement and scanning the information wherein the scanned information is stored in a memory (e.g., a non-transitory memory) of the portable panel.

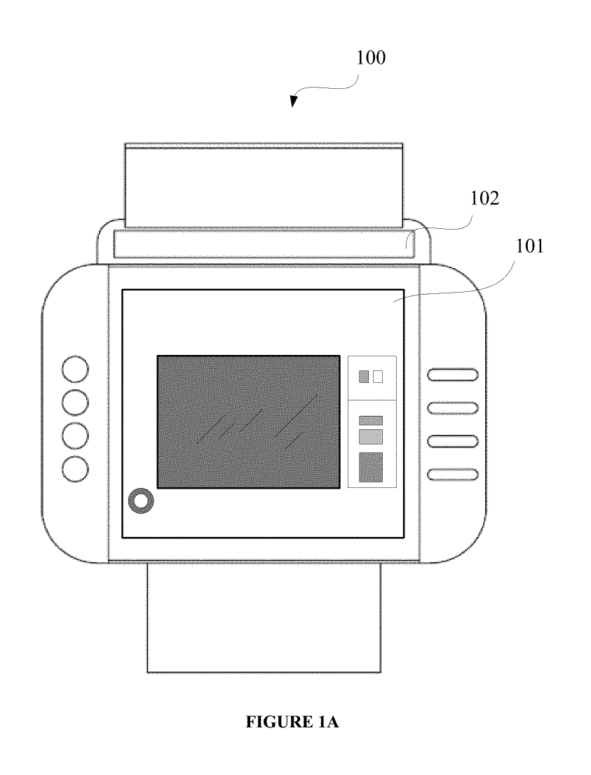

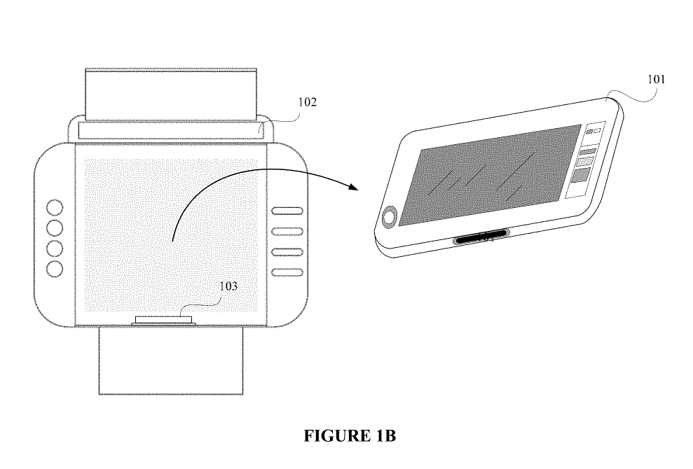

FIG. 1A illustrates a portable assembly engaged with a printer system in accordance with some embodiments of the present disclosure. FIG. 1A shows an assembly including a printer system 100, a portable panel 101 engaged with the printer system 100 and a lid 102. The printer system 100 may be a home printer system 100, a corporate printer system 100 or any other printer system 100. In at least one embodiment, the printer system 100 may be a Multi-Functional Printer (MFP). The printer system 100 may comprise but is not limited to, a printing module (not shown in figure) and a scanning module (not shown in FIG. 1A). In at least one embodiment, the printer system 100 comprises the portable panel 101 and the portable panel 101 comprises a scanning module. The portable panel 101 is configured to be disengaged from the printer system 100. The portable panel 101 is structurally designed for physical engagement with the printer system 100. Further, the printer system 100 is provided with a provision to enable physical engagement of the portable panel 101 with the printer system 100.

The portable panel 101 communicates with the printer system 100 over a physical interface configured between the portable panel 101 and the printer system 100, when the portable panel 101 is physically engaged with the printer system 100. The portable panel 101 receives instructions from the printer system 100 to perform task of scanning information from a material. For example, the material may be a physical media like papers, journals, catalogues, etc. The portable panel 101 uses the scanning module for scanning the information from the material. The material to be scanned is placed on the scanner module of the portable panel 101. Further, the portable panel 101 scans the information from the material and communicates the scanned information to the printer system 100. Here, all the communication between the portable panel 101 and the printer system 100 takes place through physical interface between the portable panel 100 and the printer system 100. Further, the portable panel 101 receives power from a power source configured in the printer system 100, when engaged with the printer system 100.

In at least one embodiment, the lid 102 helps in blocking ambient light signals entering the scanning module.

FIG. 1B shows the portable panel 101 disengaged from the printer system 100. The portable panel 101 is enabled with a scanner module even when disengaged from the printer system 100. The printer system 100 may comprise a cavity or socket for connecting with the portable panel 101. Alternatively, the printer system 100 may comprise a pin or a projection 103 for inserting into a cavity or a socket for connecting with the portable panel 101. The process of disengaging the portable panel 101 comprises manually removing the portable panel 101 from the printer system 100. The portable panel 101 communicates with the printer system 100 wirelessly, when disengaged from the printer system 100. Further, the portable panel 101 is powered by a power source configured in the portable panel 101 when disengaged from the printer system 100.

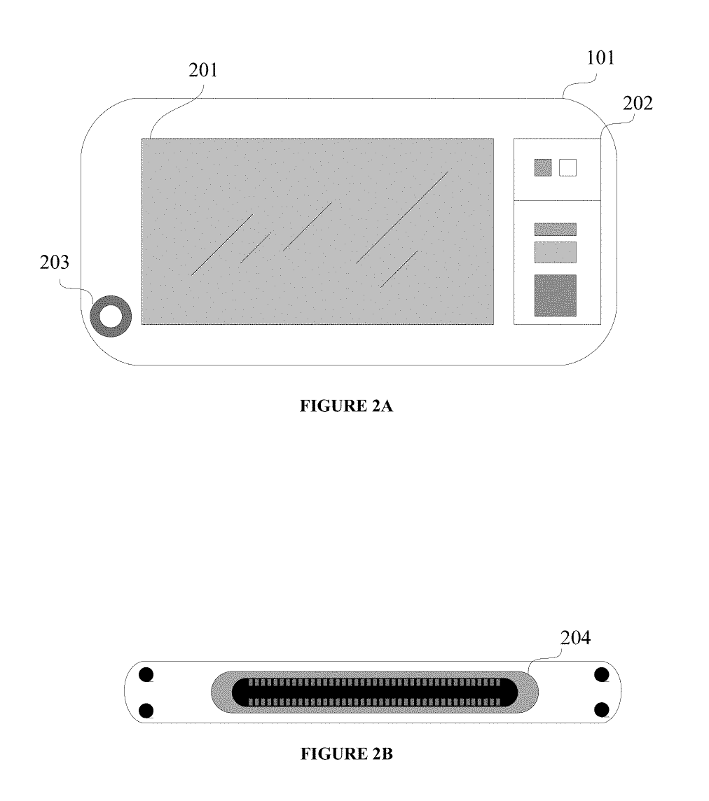

FIG. 2A illustrates an exemplary diagram of the portable panel 101 in accordance with some embodiments of the present disclosure. The portable panel 101 comprises a scanning unit (a scanner) 201, a keypad 202 and an engage/disengage button 203. In at least one embodiment, the scanning unit 201 comprises a dedicated slot, where the material to be scanned is placed. Further, the scanning unit 201 comprises hardware and software modules (not shown in figure) to read the information from the material, when placed in the dedicated slot. The scanning unit 201 scans the information when the material is placed in the dedicated slot. Further, the scanned information is stored in a memory configured in the portable panel 101. In at least one embodiment, the scanning unit 201 may comprise miniaturized hardware components. The miniaturization of the components may result in a compact scanning unit 201. Thus, the compact scanning unit 201 can be integrated into the portable panel 101.

In at least one embodiment, the keypad 202 receives inputs from a user. The keypad may comprise physical buttons or a touch panel for receiving inputs from the user. In at least one embodiment, the inputs may be scan information, photocopy information, colour type, scan parameters, photocopy parameters, or any other inputs which may be used to perform an associated operation.

In at least one embodiment, the portable panel 101 may comprise a holder mechanism or a securing means to fix the portable panel 101 in the dedicated slot of the printer system 100 firmly.

In at least one embodiment, the portable panel 101 may comprise a lid or a cover to mitigate ambient light from entering the scanning unit 201.

In at least one embodiment, the engage/disengage button 203 helps in engaging/disengaging the portable panel 101 from the printer system 100. For illustration, let us consider that when the engage/disengage button 203 is pushed, while the portable panel 101 is engaged with printer system 100, the portable panel 101 will be disengaged from the printer system 100. The engage/disengage button 203 may remain in a pushed position when the engage/disengaged button 203 is pushed. When the portable panel 101 is engaged with the printer system 100, the engage/disengage button 203 may be released, thus indicating that the portable panel 101 is successfully engaged with the printer system 100.

FIG. 2B illustrates side view of the portable panel 101. The portable panel 101 is provisioned with an interlock mechanism to physically engage with the printer system 100. In at least one embodiment, the interlock mechanism may be an electrical connector 204. The electrical connector 204 facilitates physical engagement and electrical engagement of the portable panel 101 with the printer system 100. In at least one embodiment, the electrical connector 204 may be a male connector or a female connector 204. In an exemplary embodiment, the connector 204 may be C-type Universal Serial Bus (USB) connector. For illustration, the C-type USB connector 204 of the portable panel 101 may comprise C-type USB socket 204. Further, the printer system 100 is provided with a C-type USB connector comprising C-type USB pin 103. When the portable panel 101 has to physically engage with the printer system 100, the C-type USB socket 204 of the portable panel 101 and the C-type USB pin 103 of the printer system 100 should interlock with each other. Upon successful interlocking, the portable panel 101 is physically engaged with the printer system 100. The C-type USB socket 204 and the C-type USB pin 103 also facilitate data transfer between the portable panel 101 and the printer system 100. The C-type USB connector 204 may employ serial communication protocol for facilitating data transfer between the portable panel 101 and the printer system 100. In at least one embodiment, the electrical connector 204 may be any connector that may facilitate physical connection and data transfer between portable panel 101 and the printer system 100.

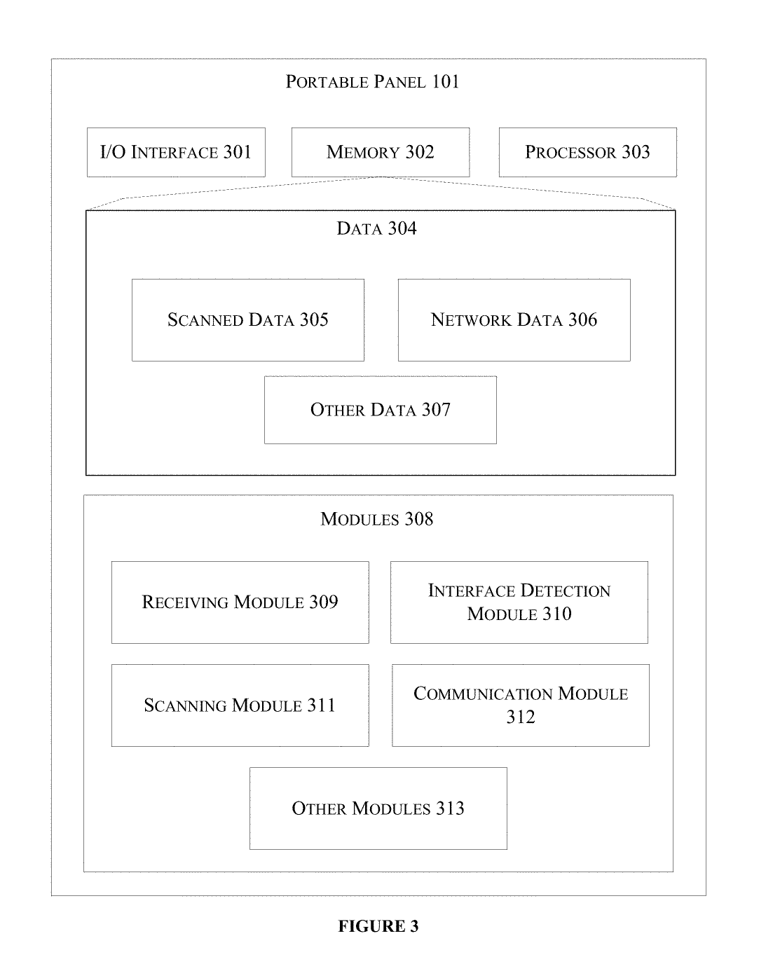

FIG. 3 illustrates an internal architecture of the portable panel 101 in accordance with embodiments of the present disclosure. The portable panel 101 may include at least one central processing unit (“CPU” or “processor”) 303 and a memory 302 storing instructions executable by the at least one processor 303. The processor 303 may comprise at least one data processor for executing program components for executing user or system-generated requests. The memory 302 is communicatively coupled to the processor 303. The portable panel 101 further comprises an Input/Output (I/O) interface 301. The I/O interface 301 is coupled with the processor 303 through which an input signal or/and an output signal is communicated. The processor 303 may be disposed in communication with one or more input/output (I/O) devices (not shown) via the I/O interface. The I/O interface may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface, the portable panel 101 may communicate with one or more I/O devices. For example, the input device may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc., but is not limited to the foregoing. The output device (not shown) may be a printer, fax machine, video display (e.g., cathode ray tube (CRT), liquid crystal display (LCD), light-emitting diode (LED), plasma, plasma display panel (PDP), organic light-emitting diode display (OLED) or the like), audio speaker, etc., but is not limited to the foregoing.

In at least one embodiment, one or more data 304 may be stored within the memory 302. The one or more data 304 may include, for example, scanned data 305, network data 306 and other data 307. The scanned data 305 includes information scanned by the scanning unit 201.

In at least one embodiment, the network data 306 includes, but are not limited to, names of networks to which the portable panel 101 is connected, passwords of the networks, command messages from the printer system 100 and portable panel 101 and status messages from the printer system 100 and portable panel 101.

In at least one embodiment, the other data 307 may include, but are not limited to, an identity (ID) of one or more printer systems 100 and the portable panel 101 and information of type of the printer system 100 compatible with the portal panel.

In at least one embodiment, the one or more data 304 in the memory 302 is processed by modules 308 of the portable panel 101. As used herein, the term module refers to an application specific integrated circuit (ASIC), an electronic circuit, a field-programmable gate array (FPGA), Programmable System-on-Chip (PSoC), a combinational logic circuit, and/or other suitable components that provide the described functionality.

In one implementation, the modules 308 may include, for example, receiving module 309, interface detection module 310, scanning module 311, communication module 312 and other modules 313. It will be appreciated that such aforementioned modules 308 may be represented as a single module or a combination of different modules.

In one implementation, the receiving module 309 receives inputs from the keypad 202. The inputs are provided by the user using the keypad 202. The inputs may include, but are not limited to, instructions to scan information, instructions to photocopy information, scan parameters and photocopy parameters.

In at least one embodiment, the interface detection module 310 detects hardware interfaced with the portable panel 101. Particularly, the interface detection module 310 detects whether the portable panel 101 is physically engaged or disengaged from printer system 100. When the interface detection module 310 detects that the portable panel 101 is physically engaged with the printer system 100, the portable panel 101 is configured to draw power from the printer system 100. When the interface detection module 310 detects that the portable panel 101 is physically disengaged from the printer system 100, the portable panel 101 is configured to draw power from the power source of the portable panel 101.

In at least one embodiment, the portable panel 101 is structurally enabled to physically engage with the printer system 100. Likewise, the printer system 100 may comprise structural provisions for physically engaging with the portable panel 101. Further, the portable panel 101 comprises electrical provisions for communicating with the printer system 100. When the portable panel 101 is physically engaged with the printer system 100, the interface detection module 310 detects the structural engagement and electrical engagement of the portable panel 101 with the printer system 100. Upon detecting the structural engagement and the electrical engagement, the interface detection module 310 provides an audiovisual indication that the portable panel 101 is successfully engaged with the printer system 100. This enables the portable panel 101 and the printer system 100 to exchange data through the electrical engagement.

In one implementation, the interface detection module 310 may detect an electronic device connected to the portable panel 101. The electronic device may be, but is not limited to, a Personal Digital Assistant (PDA), a smartphone, a tablet, a laptop, or a Personal Computer (PC).

In at least one embodiment, the scanning module 311 scans the material placed in the dedicated slot. The scanning module 311 receives instructions from the receiving module 310 for scanning information from the material placed in the dedicated slot. Then, the scanning module 311 scans the information. Further, the scanning module 311 may receive scan parameters from the receiving module 310. The scan parameters may include, but are not limited to, a format for saving scanned information, document type, color mode and document size. When the portable panel 101 is engaged with the printer system 100, the scanning module 311 scans the information and stores the scanned information in a temporary memory of the portable panel 101 for transferring the scanned information to a memory (not shown in figures) of the printer system 100 or any electronic device associated with the printer system 100. When the portable panel 101 is disengaged from the printer system 100, the scanning module 311 stores the scanned information in the memory 302 of the portable panel 101.

In at least one embodiment, the communication module 312 communicates information with the printer system 100. Here, the information may include, but is not limited to, scanned information, network information and information relating to the connection of the portable panel 101 with the printer system 100. The communication module 312 receives data to be communicated to the printer system 100, by the scanning module 311. When the portable panel 101 is engaged with the printer system 100, the communication module 312 communicates the scanned information to the printer system 100 using physical interfaces. In an embodiment, the physical interface for communicating the data to the printer system 100 may be a wired interface. When the portable panel 101 is disengaged from the printer system 100, the communication module 312 communicates the scanned information to the printer system 100 using one or more wireless interfaces.

The wireless interface may be a network to which the portable panel 101 and the printer system 100 are connected. The network may be a secured bridge network. Thus, through the wireless bridge network, the portable panel 101 is wirelessly connected to the printer system 100. The communication module 312 also communicates command messages from the portable panel 101 to the printer system 100. Here, the command messages may include, but are not limited to, instructions to print the scanned information, and/or instructions to store the scanned information in the memory of the printer system 100 or the electronic device associated with the printer system 100. Further, the communication module 312 may communicate status messages to the printer system 100. The status messages may include, but are not limited to, status of the network status, physical engagement status and scan status.

In at least one embodiment, the other modules 313 may include a display module, a notification module, etc. In at least one embodiment, the portable panel 101 may include an imaging unit (not shown in figure). The imaging unit may be a camera, for example, and captures one or more images of the material to be scanned. Further, the scanning module 311 analyses the one or more images to retrieve the information. Here, the material may not be placed in the dedicated slot. The imaging unit can capture the one or more images when the material is placed on a flat surface.

In at least one embodiment, the portable panel 101 may comprise provisions to communicate with the electronic device. The portable panel 101 may communicate with the electronic device over the internet.

In at least one embodiment, the printer system 100 may be provisioned with a surplus portable panel. Here, the surplus panel is an additional panel alongside portable panel 101, which is already provisioned with the printer system 100. The surplus portable panel can be used when the portable panel 101 is non-functional. The surplus portable panel is enabled to perform all the functions of the portable panel 101.

In at least one embodiment, the portable panel 101 can be associated with plurality of printer systems 100. Further, the portable panel 101 can be physically engaged with the plurality of printer systems 100 comprising a provision to engage physically with the portable panel 101. Furthermore, the portable panel 100 may interact with the plurality of printer systems 100 connected to the secured bridge network.

In at least one embodiment, the portable panel 101 can be wirelessly associated with an electronic device connected to the wireless network. The portable panel 101 can receive instructions from the electronic device for scanning information and communicate the scanned information to the electronic device.

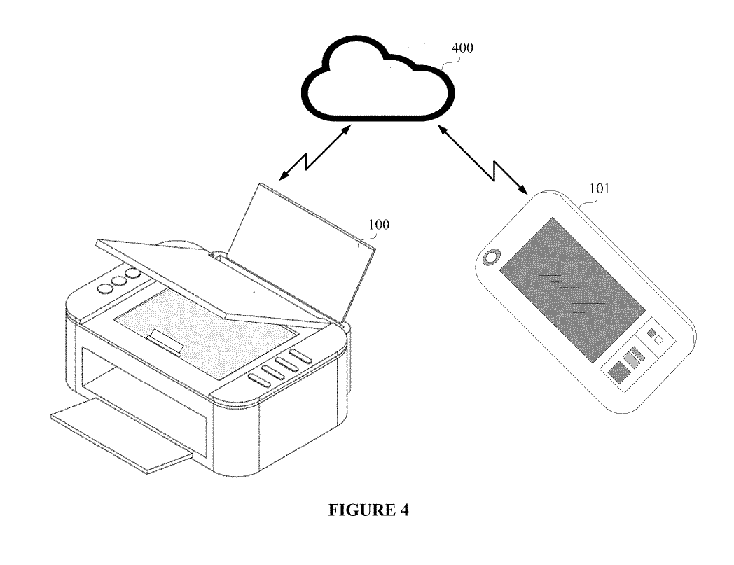

FIG. 4 illustrates wireless communication between the printer system 100 and the portable panel 101 in accordance with some embodiments of the present disclosure. In at least one, the portable panel 101 may communicate with the printer system 100 using technologies that includes, but are not limited to Bluetooth, Wireless Fidelity (Wi-Fi), Near Field Communication (NFC), Zigbee and Worldwide Interoperability for Microwave Access (WiMAX). In some embodiments, the portable panel 101 is connected to the printer system 100 through a communication network. The processor 303 may be disposed in communication with the communication network via a network interface. The network interface may communicate with the communication network. The network interface may employ connection protocols including, without limitation, direct connect, Ethernet (e.g., twisted pair 10/100/1000 Base T), transmission control protocol/Internet protocol (TCP/IP), token ring, IEEE 802.11a/b/g/n/x, etc. The communication network may include, without limitation, a direct interconnection, e-commerce network, a peer to peer (P2P) network, local area network (LAN), wide area network (WAN), wireless network (e.g., using Wireless Application Protocol), the Internet, Wi-Fi, etc. Using the network interface and the communication network, the portable panel 101 may communicate with the one or more service operators.

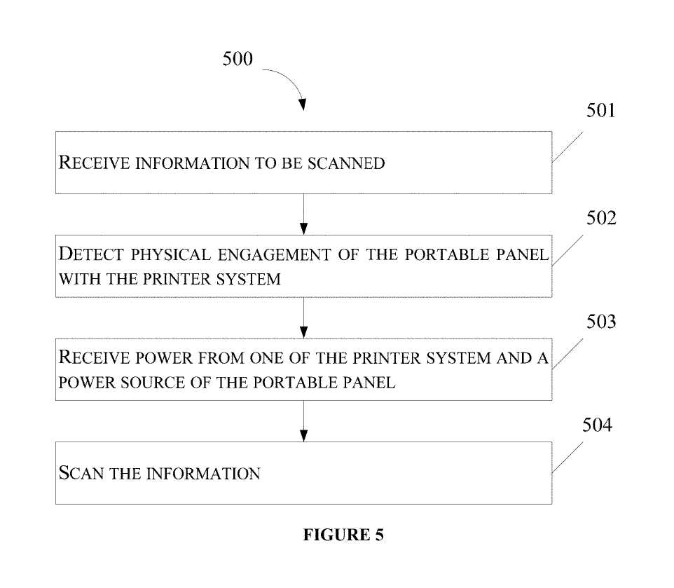

As illustrated in FIG. 5, a method 500 may comprise one or more steps for operating the portable panel 101 in accordance with embodiments of the present disclosure. The method 500 may be implemented at least in part by computer executable instructions. Generally, computer executable instructions can include routines, programs, objects, components, data structures, procedures, modules, and functions, which perform particular functions or implement particular abstract data types.

The order in which the method 500 is described is not intended to be construed as a limitation, and any number of the described method blocks can be combined in any order to implement the method. Additionally, individual blocks may be deleted or altered from the methods without departing from the spirit and scope of the subject matter described herein. Furthermore, the method can be implemented in any suitable hardware, software, firmware, or combination thereof.

At step 501, the portable panel 101 receives information to be scanned. The information may be provided as an input to the portable panel 101. The inputs may include, but are not limited to, instructions to scan information, instructions to photocopy information, scan parameters and photocopy parameters.

At step 502, the interface detection module 310 detects physical engagement of the portable panel 101 with the printer system 100. The physical engagement is detected by monitoring the interlock mechanism 204 provided in the portable panel 101.

At step 503, the portable panel 101 draws power either from the printer system 100 or the power source of the portable panel 101 based on the physical engagement of the portable panel 101 with the printer system 100. When the portable panel 101 is physically engaged with the printer system 100, the portable panel 101 is configured to receive power from the printer system 100. When the portable panel 101 is physically disengaged from the printer system 100, the portable panel 101 is configured to receive power from the power source of the portable panel 101.

At step 504, the portable panel 101 scans the information and stores the scanned information in the memory 302.

The terms “an embodiment”, “embodiment”, “embodiments”, “the embodiment”, “the embodiments”, “one or more embodiments”, “at least one embodiment,” “some embodiments”, and “one embodiment” mean “one or more (but not all) embodiments,” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of at least one embodiment with several components in communication with each other does not imply that all such components are required. On the contrary a variety of optional components are described to illustrate the wide variety of possible embodiments.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments need not include the device itself.

In at least one embodiment, the present disclosure presents the portable panel for scanning information. The portable panel can be isolated from the printer system and can be carried to various locations for scanning information.

In at least one embodiment, the portable panel can be interfaced physically and wirelessly with the printer system. Thus, the present disclosure provides a device which can be used when the portable panel is fixed to the printer system and can be used when the portable panel is isolated from the printer system.

In at least one embodiment, the portable panel can be associated with any printer system comprising a provision to physically or wirelessly engage the portable panel.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A portable assembly for a printer system, comprising:
an interlock mechanism structured to engage and disengage a portable panel from the printer system;
a scanner configured to scan information; and
a panel processor configured to
store the scanned information in a memory of the portable panel; and
perform at least one of mounting or unmounting of the portable panel from the printer system.

2. The portable assembly of claim 1, wherein the portable panel is configured to receive power from the printer system when the portable panel is engaged with the printer system.

3. The portable assembly of claim 1, further comprising a power source to power the portable panel when the panel is disengaged from the printer system.

4. The portable assembly of claim 1, further comprising:
a network interface to connect to a wireless network when the portable panel is disengaged from the printer system.

5. The portable assembly of claim 4, wherein the wireless network is a secure bridge network configured to communicate commands, status and data between the portable panel and the printer system.

6. The portable assembly of claim 5, wherein the portable panel is configured to communicate with the printer system through a physical interface when the portable panel is engaged with the printer system.

7. A printer system, comprising:
an interlock mechanism configured to engage and disengage a portable panel from the printer system;
a scanner configured to scan information; and
a panel processor configured to:
store the scanned information in a memory of the portable panel; and
perform at least one of mounting or unmounting of the portable panel from the printer system.

8. The printer system of claim 7, further comprising:
a network interface to connect to a wireless network, the network interface being configured to receive the scanned information from the portable panel when the portable panel is disengaged from the printer system;
a physical interface configured to receive the scanned information from the portable panel when the portable panel is engaged with the printer system; and
a printer processor configured to communicate with the first processor to effectuate mounting and unmounting of the portable panel from the printer system.

9. The printer system of claim 7, further comprising a power source to power the portable panel when the portable panel is engaged with the printer system.

10. The printer system of claim 8, wherein the wireless network connection is disconnected when the portable panel is disengaged from the printer system.

11. A method of operating a portable scanner of a printer system, comprising:
receiving, by the portable panel, information to be scanned;
detecting, by the portable panel, physical engagement of the portable panel with a printer system, wherein the portable panel comprises an interlock mechanism to engage with and disengage from the printer system;
receiving, by the portable panel, power from at least one of the printer system or a power source of the portable panel based on the detection of physical engagement; and
scanning, by the portable panel, the information, wherein the scanned information is stored in a memory of the portable panel.

12. The method of claim 11, wherein the portable panel is configured to receive power from the printer system when the portable panel is engaged with the printer system.

13. The method of claim 11, wherein the portable panel is configured to receive power from the power source when the portable panel is disengaged from the printer system.

14. The method of claim 11, further comprising connecting to a wireless network when the portable panel is disengaged from the printer system.

15. The method of claim 12, further comprising transferring data by the portable panel to the printer system through a physical interface when the portable panel is engaged with the printer system.

16. The method of claim 11, wherein the interlock mechanism comprises a male connector or a female connector.

17. The method of claim 11, further comprising:
providing an indication of engagement when the portable panel is engaged with the printer system.
